(19) United States
(12) Patent Application Publication
(10) Pub. No.: US 2026/0289354 A1
(43) Pub. Date: Sep. 24, 2026

(54) Standardized Governance Layer for Autonomous Multi Agent Systems and Proof Conditioned Digital Markets

(71) Applicant: DARIO CHANG, DORAL, FL (US)

(72) Inventor: DARIO CHANG, DORAL, FL (US)

(21) Appl. No.: 19/691,633

(22) Filed: May 29, 2026

Related U.S. Application Data
(63) Continuation-in-part of application No. 19/436,204, filed on Dec. 30, 2025.

(51) Int. Cl. G06N 5/043; G06F 11/30; G06F 40/30

(52) U.S. Cl. CPC G06N 5/043; G06F 11/302; G06F 40/30

(57) ABSTRACT

A standardized governance layer for autonomous multi-agent systems is disclosed. The system extends the temporal-scoring and state-transition primitives of Cycle Hits and Hits History to agent identity, provenance, arbitration, and settlement in distributed AI markets. An Agent Identity Envelope provides canonical lineage, capability descriptors, and cryptographic provenance digests. A behavior-ingestion pipeline computes cyclical behavior vectors and time-decayed interaction vectors for agent-level temporal scoring. An IPS fusion engine generates proof-conditioned trust scores used for arbitration, coordination, and settlement. Agents exchange verifiable proof bundles through a proof-exchange protocol supporting composite verification and regulator-auditable disclosures. A settlement engine performs threshold validation, atomic commit, and issuance of finality proofs. A synchronization module anchors agent state transitions to distributed ledgers and propagates rotation policies and governance constraints. The architecture generalizes prior primitives to support interoperable, verifiable, and auditable coordination of autonomous agents across heterogeneous digital ecosystems.

### CROSS-REFERENCE TO RELATED APPLICATIONS

This application is a Continuation-in-Part of U.S. patent application Ser. No. 10/605,894, filed Nov. 4, 2003, titled “System and Method of Promote Website Using Cycle Hits and Hits History.”

This application further continues U.S. Patent Application, filed Dec. 30, 2025 and published as US 2026/0127578, titled “Trusted Monetization and Provenance Platform for AI+Blockchain Markets.”

This application further continues U.S. Patent Application No. 2026/0070215, filed Aug. 29, 2025 and published Mar. 12, 2026, titled “Emotion Aware Cognitive Operating System Using Multi-Agent Prediction, Cycle Hit Scoring and Intuitive Knowledge Calibration.”

The disclosures of all referenced applications are incorporated herein by reference in their entirety.

This CIP extends the governance primitives first disclosed in 2003—including Cycle Hits (2003 ¶¶ 0020-0032), Hits History (2003 ¶¶ 0033-0045), behavioral scoring (2003 ¶¶ 0046-0052), and execution gating (2003 ¶¶ 0053-0061)—into modern multi-agent AI systems, distributed orchestration environments, and heterogeneous model-selection architectures.

### FIELD OF THE INVENTION

The invention relates to governance-layer orchestration for autonomous AI agents operating in digital markets.

More specifically, the invention concerns agent identity envelopes, agent-level provenance, agent-to-agent proof exchange, agent-conditioned behavior rules, agent-level settlement, arbitration, insurance logic, cross-agent synchronization, and regulator-auditable state transitions.

### BACKGROUND OF THE INVENTION

### 2003 Primitive: Cycle Hits+Hits History

The 2003 parent application introduced a two-part governance primitive:
Cycle Hits: temporal velocity measurement
Hits History: persistent behavioral baseline

Cycle Hits (2003 ¶¶ 0020-0032) described:
“a time-based cycle window” (¶ 0024)
“counting repeated interactions within said window” (¶ 0026)
“detecting abnormal velocity patterns” (¶ 0030)

Hits History (2003 ¶¶ 0033-0045) described:
“a stored history of prior interactions” (¶ 0034)
“comparing current cycle activity to historical baselines” (¶ 0038)
“determining legitimacy based on historical patterns” (¶ 0041)

Execution Gating (2003 ¶¶ 0053-0061) described:
promoting or demoting assets
preventing manipulation
gating execution based on behavioral scoring

These primitives form the ancestral governance layer for modern AI systems.

### Evolution of the Primitive (2004-2024)

Modern systems implement the same primitive using:
event-stream ingestion
sliding-window computation
in-memory telemetry
distributed historical logs

These correspond directly to:
Cycle Hits→sliding windows
Hits History→distributed logs
Execution gating→anomaly -based routing

### Modern Workarounds (2023-2026)

Attempts to avoid the primitive include:
replacing time windows with DAG depth limits
replacing history tables with vector embeddings
replacing centralized kernels with decentralized swarms
replacing agent governance with model-selection routers
replacing application-level throttling with hypervisor-level throttling

This CIP closes all such workarounds by generalizing the primitive.

### Integration with 2026/0070215 (Agentic OS)

The 2026 OS introduced:
multi-agent orchestration
stratified memory
cyclehit scoring
history score values
agent selection and coordination
cognitive-load negotiation
certification APIs

These extend the 2003 primitive into:
agent prediction
agent orchestration
memory-layer personalization

### Integration With 2026/0127578 (Monetization & Provenance)

The 2026 monetization platform introduced:
canonical serialization
cryptographic attestations
composite proof verification
IPS tokens
rotation gateways
adaptive settlement engines
micro-market orchestration
selective disclosure proofs
adversarial robustness pipelines

These extend the 2003 primitive into:
verifiable monetization
cross-chain provenance
tamper-evident settlement

### SUMMARY OF THE INVENTION

The invention provides a generalized governance layer for multi-agent systems, comprising:
progression metrics
historical state representation
arbitration
routing
safety
resource control
monetization
provenance

These components collectively extend the 2003 primitive into modern AI ecosystems.

### TEXT-ONLY FIGURE DESCRIPTIONS (NO DRAWINGS)

5.1 FIG. 1—Textual description of the 2003 Cycle Hit/Hits History primitive.
5.2 FIG. 2—Textual description of modern sliding-window telemetry.
5.3 FIG. 3—Textual description of generalized progression metrics.
5.4 FIG. 4—Textual description of behavioral memory fabric.
5.5 FIG. 5—Textual description of arbitration mechanisms.
5.6 FIG. 6—Textual description of model-selection routing.
5.7 FIG. 7—Textual description of resource-control layers.
5.8 FIG. 8—Textual description of proof-conditioned monetization flow.

### DETAILED DESCRIPTION OF THE INVENTION

### Mapping the 2003 Primitive to Modern Systems

### Cycle Hits→Generalized Progression Metric

2003 ¶ 0024 described “a time-based cycle window.”2003 ¶ 0026 described “counting repeated interactions within said window.”

Modern equivalents include:
sliding windows
DAG depth
token consumption
semantic repetition
structural loop detection

Thus, Cycle Hits generalizes to: any measurement of agent progression, repetition, or stalling.

### Hits History→Behavioral Memory Fabric

2003 ¶ 0034 described “a stored history of prior interactions.”2003 ¶ 0038 described “comparing current cycle activity to historical baselines.”

Modern equivalents include:
distributed logs
vector embeddings
probabilistic memory
latent state encodings

Thus, Hits History generalizes to: any persistent representation of prior behavior.

### Execution Gating→Arbitration Layer

2003 ¶ 0053 described “promoting or demoting assets.”2003 ¶ 0057 described “preventing manipulation or runaway behavior.”

Modern equivalents include:
agent termination
task reassignment
model selection
compute throttling

Thus, execution gating generalizes to: any arbitration of agent execution rights.

### Closing Modern Workarounds (Functional Rebuttals)

DAG depth→still progression.

Embeddings→still historical state.

Decentralized swarms→still arbitration.

Model-selection→still governance.

Hypervisor throttling→still execution control.

### GENERALIZED GOVERNANCE LAYER

The invention comprises:
monitoring
progression scoring
historical memory
arbitration
routing
safety
resource control
monetization

Each is described in detail in the claims.

### GENERALIZED EMBODIMENT SUPPORT

The governance-layer architecture described herein is expressed in generalized functional terms to support future embodiments, variants, and extensions. The primitives disclosed—including identity envelopes, temporal scoring, behavioral vectors, IPS fusion, proof exchange, settlement logic, arbitration logic, synchronization mechanisms, and regulator-auditable transitions—are not limited to the specific examples or data structures described.

Any mechanism performing equivalent functions, including alternative scoring metrics, alternative historical-state representations, alternative arbitration mechanisms, alternative settlement workflows, alternative synchronization topologies, or alternative provenance encodings, is within the scope of the present invention.

The invention is intended to support future continuations, continuation-in-part applications, divisional applications, and claim expansions that capture additional governance-layer behaviors, agent coordination patterns, negotiation protocols, model-selection logic, resource-control mechanisms, or monetization and provenance workflows.

END OF SPECIFICATION

1. A computerized multi-agent governance system, comprising:
a monitoring component configured to observe behavioral outputs of a plurality of autonomous software agents;
a progression-evaluation component configured to compute a progression metric representing advancement, stalling, or repetitive behavior of said agents;
a historical-state component configured to maintain a persistent representation of prior agent behavior;
an arbitration component configured to determine execution rights, continuation rights, or termination rights of said agents based on said progression metric and said historical representation;
a routing component configured to select, dispatch, or reassign computational models or agent roles based on said arbitration;
a safety component configured to validate identity, provenance, or trustworthiness of said agents; and
a resource-control component configured to regulate computational resources allocated to said agents;
wherein the governance system enforces coordinated execution, safety, and monetization of said agents across heterogeneous computing environments.

2. The system of claim 1, wherein the progression metric comprises any temporal, structural, semantic, or token-based measurement of agent advancement or repetition.

3. The system of claim 1, wherein the historical-state component comprises any deterministic or probabilistic memory structure, including tables, vectors, embeddings, or latent state encodings.

4. The system of claim 1, wherein the arbitration component is implemented through centralized control, distributed consensus, peer-to-peer verification, or hybrid governance.

5. The system of claim 1, wherein the routing component is configured to select among heterogeneous computational models based on confidence scores, similarity metrics, or contextual scoring.

6. The system of claim 1, wherein the resource-control component regulates agent execution at the application, operating system, virtual machine, hypervisor, or serverless orchestration layer.

7. The system of claim 1, wherein the safety component verifies identity, lineage, trust, or provenance of agents prior to execution.

8. A method for governing autonomous software agents, comprising:
monitoring behavioral outputs of a plurality of agents;
computing a progression metric representing advancement, stalling, or repetition;
maintaining a persistent historical representation of agent behavior;
arbitrating execution rights based on said progression metric and historical representation; and
routing or selecting computational models based on said arbitration.

9. The method of claim 8, wherein computing the progression metric comprises evaluating temporal cycles, structural depth, semantic repetition, or token-based limits.

10. The method of claim 8, wherein maintaining the historical representation comprises storing tables, vectors, embeddings, probabilistic states, or latent representations.

11. The method of claim 8, further comprising performing arbitration through centralized, decentralized, or hybrid mechanisms.

12. The method of claim 8, further comprising regulating computational resources at the application, operating system, virtual machine, or hypervisor layer.

13. A non-transitory computer-readable medium storing instructions that, when executed, cause a processor to perform the method of claim 8.

14. The medium of claim 13, wherein the instructions cause the processor to compute a progression metric comprising temporal, structural, semantic, or token-based measurements.

15. The medium of claim 13, wherein the instructions cause the processor to maintain a historical representation comprising tables, vectors, embeddings, or probabilistic states.

16. The medium of claim 13, wherein the instructions cause the processor to perform arbitration through centralized or decentralized governance. Architecture-Closing Dependent Claims (Sniper Claims, but SAFE) (These target the workarounds without naming any company.)

17. The system of claim 1, wherein the progression-evaluation component detects semantic repetition patterns in agent-generated text or code across consecutive generations.

18. The system of claim 1, wherein the historical-state component computes behavioral trust using multidimensional vector similarity or embedding-based scoring.

19. The system of claim 1, wherein the resource-control component regulates agent execution by monitoring compute velocity or resource consumption at a virtualized or serverless orchestration layer.

20. The system of claim 1, wherein the arbitration component performs agent arbitration through distributed peer-to-peer consensus, swarm-based verification, or equivalent decentralized mechanisms.
